(19) United States
(12) Patent Application Publication
(10) Pub. No.: US 2006/0104161 A1
(43) Pub. Date: May 18, 2006

(54) Watch case base and method for making same

(76) Inventors: Philippe Stalder, La Chaux-De-Fonds (CH); Alain Maillard, La Chaux-de-Fonds (CH); Daniel Boillod, Cernier (CH)

Correspondence Address: YOUNG & THOMPSON, 745 SOUTH 23RD STREET, 2ND FLOOR, ARLINGTON, VA, 22202, US

(21) Appl. No.: 10/527,817

(22) PCT Filed: Jul. 17, 2002
(86) PCT No.: PCT/CH02/00397

§ 371 Date: Oct. 24, 2005

(30) Foreign Application Priority Data
Dec. 14, 2001 (CH) 2301/01

(51) Int. Cl. G04B 37/00

(52) U.S. Cl. 368/309

(57) ABSTRACT

Back of a watch case including a cover (4) that defines the external surface of the back, and a false back (11) that is mounted against the internal surface of the cover. The false back can be provided with an engraved decoration and can be manufactured by stamping from a plate of even thickness. A transponder can be housed between the cover and the false back.

This invention relates to the back of a watch case and a process of manufacture of the back of a watch case. This invention in particular relates to the back of a watch case with an internal surface that is provided with decoration.

Watch cases comprise a middle and a back that can be screwed or clipped onto the middle. The back must be able to be opened to access the watch movement, for example to replace a battery or for repairs or maintenance of the movement. Many luxury watch cases are provided with a back, of which the aesthetic aspect of the internal surface is carefully done. For example, backs of watch cases are known with an internal surface that is provided with decoration, for example an engraved pattern, or by ornamentation with guilloche into the thickness of the metal.

The backs of watch cases are most often produced by punching. The internal surface of the backs of watch cases is generally concave and has indentations or threads for attachment to the middle and to maintain a seal. It is therefore difficult to automate decoration of this surface. For this reason, the decoration of the internal surface of the back is most often done manually. Guilloche back patterns that are highly valued are generally done using a special graver and a small hammer in order to make more or less regular circles in the thickness of the back. These operations are very expensive.

One object of this invention is to propose a back of a watch case and a process of manufacture of the back of a watch case that has the same aesthetic qualities as the known decorated backs of watch cases but that can be produced at a lower cost.

Moreover, watches containing an identification element, for example a transponder, which can be interrogated via an inductive reading device, are already known. Transponders are used especially to store information there that gives access to protected areas, for example as an identification element in a business or as a movie admission ticket or for ski lifts. It has likewise already been suggested that the serial number of the watch be inscribed in the identification element in the watch. These data can be read for example by the after-sales service department to check the series to which the watch belongs. Thus, the identification element makes it possible to replace or complete the serial number ordinarily engraved on the back of watch cases.

In a watch, the antenna of the transponder is generally installed just over or under the face or sometimes in the bezel; these arrangements sometimes engender major restrictions, given the small space available in a watch, and do not allow marking of watches comprising a metallic case. Moreover, the antenna is generally visible: this is not attractive, and it is exposed to impacts and vibrations. For these reasons, placing the transponder against the internal surface of the back of the watch would be preferable. This arrangement is sometime incompatible with the decorated backs of watch cases. Moreover, the transponder and especially its antenna are subject to the risk of damage when the back of the case is opened carelessly.

Another object of this invention is thus to propose a back of a watch case that makes it possible to incorporate a transponder or some other identification element.

These objects are achieved by way of a back of a watch case and a process of manufacture with the claimed characteristics.

In particular, these objects are achieved by way of a back of a watch case comprising a cover that defines the external surface of the back, and a false back mounted against the internal surface of said cover.

This approach has the advantage of separating the manufacture of the cover, which often requires punching operations, tapping operations, etc., from production of the false back that requires other, simpler stamping operations (cutting) and decoration operations. It is thus possible to optimize the processes used for production of these two elements.

In particular, it is possible to produce the false back by cutting on a plate of even thickness that has been decorated beforehand. The decoration of a plate of even thickness can be automated and performed using a machine.

It is thus possible to decorate, in a single operation, a plate that is intended for production of several tens of false watch backs. Decoration can be done, for example, by engraving in the thickness of the plate.

This approach, moreover, has the advantage of allowing an electronic identification element to be placed between the cover and the false back. This identification element can be completely hidden between the cover and the false back. It has no adverse effect on the internal or external aesthetics of the watch and is completely protected against any damage, even in the case of opening the back. Moreover, the false back contributes to increasing the strength and rigidity of the back; it is thus possible to reduce the thickness of the cover, which offers the advantage of facilitating inductive reading through the back. This advantage is especially important in the case of a back of a watch case made of metal that highly attenuates radio waves transmitted to and from the transponder.

The prior art discloses watches with a back that includes additional elements. In particular, CH 335610 describes a watch that has a back, i.e., an element that closes the middle in a stationary manner, on the external surface of which a lining of synthetic material is added, intended mainly to protect the watch from marks in case of contact with foreign bodies. However, this lining is not comparable to the false backs of this invention. In particular, this lining is located on the external surface of the back of the watch and not on its internal surface. Thus, it cannot in any way contribute to reducing the costs incurred by decoration of the internal surface of the back of the watch.

U.S. Pat. No. 1,404,656 describes a watch with a case that is composed of a precious metal outer case, reinforced, among others, by an internal case of a less expensive material. The case of this watch, however, does not comprise a back allowing easy access to the movement without removing the latter from the case. Moreover, the internal case is completely hidden by the external case and does not perform any aesthetic function.

The invention will be better understood by reading the description that is given by way of example and illustrated by the attached figures, among which:

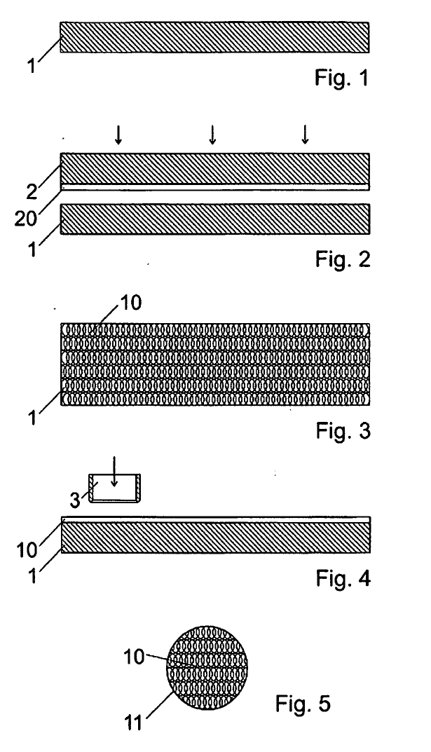

FIG. 1 is a cutaway view of a rough plate intended for production of several false backs according to the invention.

FIG. 2 is a cutaway view of the same plate during the operation of decoration by engraving of the upper surface.

FIG. 3 is a top view of the plate after decoration, showing a guilloche pattern.

FIG. 4 is a cutaway view of the plate during the operation of cutting by stamping.

FIG. 5 is a top view of a false back of the watch that is decorated and cut according to the invention.

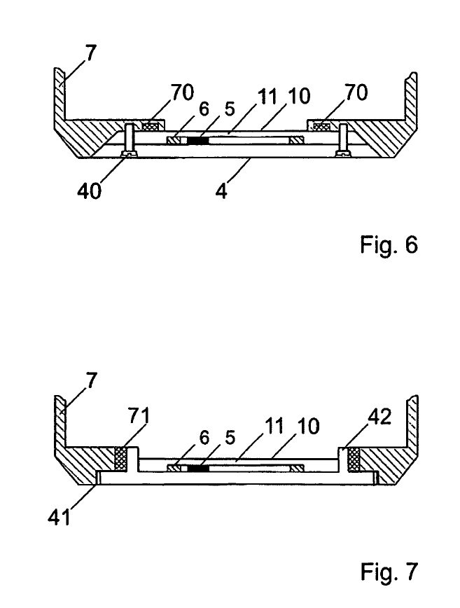

FIG. 6 is a partial cutaway view of a watch case provided with a first variant of a watch back according to the invention.

FIG. 7 is a partial cutaway view of a watch case provided with a second variant of a watch back according to the invention.

FIG. 1 shows a plate 1 of even thickness that is intended for production of a plurality of decorated false backs of watch cases in a reduced number of operations. The plate is preferably metal, preferably the same metal as the one used for the back of the watch.

The upper visible surface of the plate is decorated in a single operation, for example by way of a stamp 2 pressed against the entire surface of the plate 1 and provided with a punch 20 (FIG. 2). The size of the stamp 2 can correspond to that of the plate 1, as shown in FIG. 2, or can be smaller and applied several times. It is also possible to engrave the upper surface of the plate 1 by passing it between two rollers, one with a relief pattern, or to apply decoration to the plate 1 by another process, for example by screen printing, plating, anodizing, etc. Preferably, however, surface treatment of the plate that is identical to that used for the other parts of the back is to be chosen, in order to make the use of a false back as inconspicuous as possible.

FIG. 3 shows the upper surface of the decorated plate 1. In this example, the pattern 10 applied by stamping resembles known guilloche patterns.

The plate 1 is then cut, preferably by way of a punch 3 as shown in FIG. 4. It is, of course, also possible to cut several false backs at the same time on the same plate and/or to cut and decorate the plate 1 in a single operation and using the same stamp. It is also possible to perform several separate decorating operations on the same plate 1.

Moreover, additional machining operations that are not shown can be performed on the false back 11, for example to mill a cavity (shown in FIGS. 6 and 7) that is intended to house an electronic component, for example an identification element 5 and a coil 6. This cavity can also be obtained by stamping. It is also possible to deform the lower surface of the false back by stamping in order to adapt it to the internal shape of the cover.

FIG. 5 shows a top view of a false back 11 of a watch decorated by way of a guilloche pattern 10.

FIG. 6 shows a partial sectional drawing of a watch case comprising a middle 7 and a back 11, 4 according to a first variant of the invention. The back includes a cover 4 and a false back 11 that has been produced using the above-described process. The cover and the false back are provided with holes for screws 40 for attachment to the middle 7. A seal 70 makes it possible to prevent infiltration of water between the middle and the back. In this example, an identification element composed here of a transponder 5 equipped with an antenna 6 is housed in a cavity between the false back 11 and the cover 4. The thickness of the cover 4 is preferably reduced in order to limit the attenuation of the electromagnetic field through this wall. Definitive tests were performed with a cover thickness of roughly 5 to 7 tenths of a millimeter depending on the material used. The rigidity and strength of the back are nevertheless guaranteed thanks to the false back 11 that can be cemented onto the cover 4 or simply attached using screws 40.

The antenna 6 is composed of a coil formed by winding a copper wire and connected by bonding directly to the lugs of the circuit 5. The circuit 5 can be fixed in the cavity by way of a two-sided self-adhesive film stamped to the size of the adhesive housing. The circuit 5 placed on the self-adhesive film is transported by suction to be deposited on the bottom of the recess. Especially during this operation, special care must be taken to avoid breaking the antenna wire, and, if necessary, it will be possible to check proper operation of the identification elements by reading its contents after installation.

The circuit 5 can, moreover, be coated with resin. Definitive tests were performed by supplying an exact amount of very pure epoxy resin via a metering apparatus. To ensure that the resin spreads perfectly as it fills the cavity, a centrifuge or a vibration device could be used during polymerization of the resin.

It is especially important to prevent the rising of the resin during polymerization from breaking the wires of the antenna 6. To avoid this risk, for example, polymerization should proceed slowly as the back 11, 4 is stored at ambient temperature for at least 24 hours or as it is heated to a moderate temperature, roughly 35° C.

The identification element 5 is preferably supplied with electricity solely by the inductive writing device and/or reading-writing device used to access the stored data, without calling on the watch battery. It comprises a modulator-demodulator, which is not shown, to receive and demodulate the signals of the inductive reading-writing device, and to modulate and transmit the responses. In the case of a metallic back, the circuit 5 preferably uses a frequency that is distinctly lower than those ordinarily used for standard RFID elements, preferably a frequency of less than 50 kHz, in order to allow transmission through the metal. An encryption and/or electronic signature module can, moreover, be provided in the circuit 5 in the case in which confidential data, for example medical data or amounts of money, should be stored in one or more fields of the memory zones.

The circuit 5 preferably comprises a memory zone that is not shown, including a program area as well as a data area. The watch back can thus be personalized by writing the data of the manufacturer and/or the retailer (serial number, date of manufacture, lot number, etc.) in the data area. Personalization can be done by the manufacturer of the watch after the back is mounted on the watch or more easily by the manufacturer of the backs before assembly of the watch on the database and serial numbers provided by the watch manufacturer, for example, on a diskette or via e-mail. The memory zone can also be modified by the application suppliers after sale of the watch, for example to write access codes there for the protected areas.

In one preferred variant of the invention, the serial number of the watch is, moreover, engraved on the external surface of the back. This characteristic makes it possible to check the serial number of the watch without the special reading device.

FIG. 7 shows a second variant of the back of the watch case provided with a false back 11 according to the invention. In this variant, the cover is provided with peripheral threads 41 that allow it to be screwed directly onto the middle 7. A seal 42 between the middle 7 and a projection 42 of the cover make it possible to prevent infiltration of water. As in the variant above, the false back 11 is placed on the cover 4 and secured, for example, by cementing. An identification element 5, 6 can be placed between the cover 4 and the false back 11.

One skilled in the art will understand that other systems of attachment of the back to the middle, by clips or via screws, can be used within the framework of this invention.

1. Back of a watch case comprising a cover (4) that defines the external surface of the back, characterized by a false back (11) installed against the internal surface of said cover.

2. Back of a watch case according to the claim 1, wherein said false back (11) comprises a decoration (10) on the mirror-side surface.

3. Back of a watch case according to claim 2, wherein said decoration (10) is marked in the thickness of said false back (11).

4. Back of a watch case according to claim 1, wherein said false back (11) has an even thickness and wherein said cover (4) comprises means of attachment (40, 42) to the middle (7) of the watch case.

5. Back of a watch case according to claim 1, wherein said false back (11) is attached securely against said internal surface of said cover (4).

6. Back of a watch case according to claim 1, wherein an identification element (5, 6) is installed between said cover (4) and said false back (11).

7. Back of a watch case according to claim 1, wherein said identification element comprises an electronic circuit (5) and an antenna (6) installed in a cavity between said cover and said false back.

8. Back of a watch case according to claim 7, wherein said electronic circuit (5) is fixed in said cavity by way of a double-sided adhesive.

9. Back of a watch case according to claim 7, wherein said electronic circuit (5) is coated with resin.

10. Back of a watch case according to claims claim 1, wherein said cover (4) and/or said false back (11) are metal.

11. False back (1) intended to be installed against the internal surface of a cover (4) of the back of a watch case and comprising a surface provided with decoration (10).

12. Process of production of the back of a watch case, comprising the following step:
installation of a false back (11) against the internal surface of the cover (4) of the back.

13. Process according to claim 1, comprising, moreover, a prior step of stamping of said false back (11) from a plate (1) of even thickness.

14. Process according to claim 13, comprising, moreover, a prior step of engraving of a decoration (10) on one surface of said plate.

15. Process according to claim 12, comprising, moreover, a step of insertion of an electronic identification element (5) between said cover (4) and said false back (11).
